(19) United States
(12) Patent Application Publication
(10) Pub. No.: US 2020/0410607 A1
(43) Pub. Date: Dec. 31, 2020

(54) AIRLINE PILOT INFORMATION PORTAL

(71) Applicant: Terrance Lamont Ford, Indian Head, MD (US)

(72) Inventor: Terrance Lamont Ford, Indian Head, MD (US)

(21) Appl. No.: 16/999,682

(22) Filed: Aug. 21, 2020

Related U.S. Application Data
(60) Provisional application No. 62/866,211, filed on Jun. 25, 2019.

(51) Int. Cl. G06Q 50/00; G06F 3/0481; G06Q 30/02; G06F 16/9535

(52) U.S. Cl. CPC G06Q 50/01; G06F 3/0481; G06Q 30/0185; G06Q 30/0282; G06F 16/9535; G06Q 30/0203

(57) ABSTRACT

A pilot information portal enables airline passengers to view airline pilots operating their flight and leave comments relating to their pilot and their flight experience. The pilot information portal includes pilot avatars corresponding to each pilot that may be viewed by portal users and may be presented specifically to airline passengers when they book a flight piloted by the corresponding pilot. Each pilot avatar may display biographical information, credentials, flight history, and one or more photographs of the pilot. Portal users may view information and interact via a user interface which, in addition to displaying pilot data, may also display flight or ticket data, and provide a digital network which enables the user to post and browse comments associated with their pilot.

### CROSS-REFERENCE TO RELATED APPLICATION(S)

The present application is related to and claims priority to U.S. Provisional Patent Application No. 62/866,211 filed Jun. 25, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of social media platforms of existing art and more specifically relates to an airline pilot information portal.

### RELATED ART

Airline travel can be frightening and worrisome. Often, one of the most reassuring aspects of taking an airline flight is the interaction between airline passengers and airline staff, particularly pilots. Airline passengers who are assured of their pilot's experience and find their pilot personable may be more comfortable with their flying experience. Some people may be concerned with their pilot's personality and wish to examine the pilot from a closer perspective. Accordingly, there is perceived a need for a system which enables airline passengers to become more familiarized with their pilot on a given flight.

U.S. Pat. No. 10,068,487 to Douglas Nolen Shorter, Jr. et al. relates to a comprehensive flight planning tool for a mobile device. The described comprehensive flight planning tool for a mobile device includes a mobile application for providing a flight planning tool on a client device. The mobile application may include a data input module configured to receive, via interface hardware on the client device, a selection of one of a plurality of selectable tools. The mobile application may further include a graphics module configured to display, via the interface hardware, a user interface associated with the selection. The mobile application may further include a flight planning communication module configured transmit a request for information associated with the selection, via an API, to a flight planning system, and receive, from the flight planning system via the API, responsive information that fulfills the request, wherein the responsive information was generated by the flight planning system based on information from a third-party device.

### SUMMARY OF THE INVENTION

In view of the foregoing disadvantages inherent in the known social media platform art, the present disclosure provides a novel airline pilot information portal. The general purpose of the present disclosure, which will be described subsequently in greater detail, is to provide an airline pilot information portal.

A pilot information portal enables airline passengers to view airline pilots operating their flight and leave comments relating to their pilot and their flight experience. The pilot information portal includes pilot avatars corresponding to each pilot that may be viewed by portal users and may be presented specifically to airline passengers when they book a flight piloted by the corresponding pilot. Each pilot avatar may display biographical information, credentials, flight history, and one or more photographs of the pilot. Portal users may view information and interact via a user interface which, in addition to displaying pilot data, may also display flight or ticket data, and provide a digital network which enables the user to post and browse comments associated with their pilot.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an airline pilot information portal, constructed and operative according to the teachings of the present disclosure.

FIG. 1 is a perspective view of the pilot information portal during an ‘in-use’ condition, according to an embodiment of the disclosure.

FIG. 2 is a perspective view of the pilot information portal of FIG. 1 illustrating an example graphic design of the user-interface, according to an embodiment of the present disclosure.

FIG. 3 is a perspective view of the pilot information portal of FIG. 1 illustrating an example graphic design of the user-interface, according to an embodiment of the present disclosure.

FIG. 4 is a perspective view of the pilot information portal of FIG. 1 illustrating an example graphic design of the review-page, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a social media platform and more particularly to an airline pilot information portal as used to improve the social interaction between an airline passenger and an airline pilot.

The airline pilot information portal provides users with a system and a smartphone application designed to allow aircraft passengers to see who their pilot is for a specific flight. Effectively, the system enables potential flight passengers to have peace of mind that their pilot is safe and experienced. A user interface can display information regarding the pilot next to his/her picture, including age, height, weight, education, and the like. The system includes a comment section to post good or bad reviews about specific pilots. The system is advantageous in that it offers a way to connect with other passengers and share information about specific pilots and airlines during a flight.

The airline pilot information portal may include a user interface. The user interface may be a software application (especially for a smartphone) available to airline passengers and useful for browsing information about airline pilots. Each pilot and co-pilot employed by specific airlines will have a profile on the application. The profile can supply information about the pilot and an image of him/her. Information can include flying hours, age, height, weight, education, and more. There can be comment sections for sharing information about pilots and airlines. Users are able to get a more accurate and personal picture of their pilot before flying. When using the application, a user must enter their ticket number or flight number in a provided space in order to receive pilot profile information. The software application may display the user's ticket information if the user is logged into a personal user account. The application may automatically display information for a pilot and co-pilot corresponding to the ticket information. However, users may also have the option of browsing other pilots in the database.

Further, a display interface may interact with the same server as the user interface, but may be controlled from a client device to act as a display system rather than an interactive media interface. The display interface may selectively display flight information, pilot information, or a combination of the two. The display interface may display flight information along with information of the corresponding pilot and co-pilot. Such a display interface may be useful for displaying to airline passengers in a waiting area, especially a gate for a particular flight, for example.

It should be understood that for the purposes of this specification, “airline pilot” is a term used generically for a transportation conductor. Substitutes for an actual airline pilot may include train conductors, bus drivers, and other operators. It is envisioned that the elements of the pilot information portal may be applicable to operators of a wide variety of public transportation types.

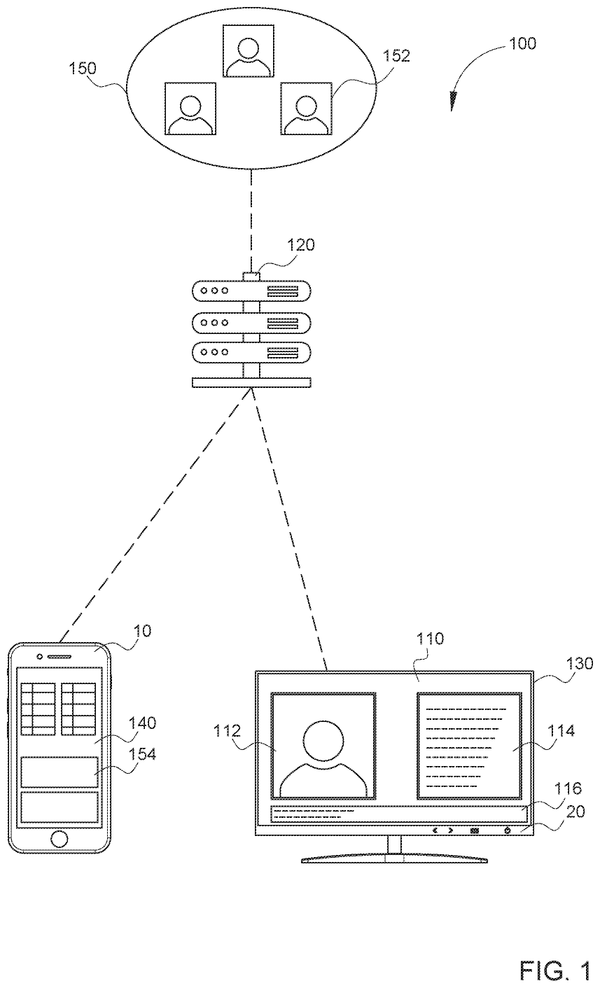

Referring now more specifically to the drawings by numerals of reference, there is shown in FIGS. 1-4, various views of a pilot information portal 100.

FIG. 1 shows a pilot information portal during an ‘in-use’ condition, according to an embodiment of the present disclosure. Here, the pilot information portal may be beneficial for use by a user to enact social interaction and information sharing between an airline passenger and an airline pilot. The pilot information portal 100 may include at least one pilot avatar 110, server 120 servicing one or more client-side devices, at least one client-side display interface 130, user-interface 140, and social-network 150 accessible via user-interface 140. User-interface 140 may display ticket information in some embodiments. At least one pilot avatar 110 may correspond to a pilot and may include: at least one image 112 depicting a face of the pilot; biographical information 114 of the pilot; and credentials 116 of the pilot. Other information may be provided as well. Server 120 may contain digital information. This digital information may include at least one pilot avatar 110. At least one client-side display interface 130 may be in digital communication with server 120, and may be able to display the at least one pilot avatar 110. User-interface 140 may enable a user to browse at least one pilot avatar 110. Social-network 150 may be accessible via user-interface 140. Social-network 150 may include at least one user-profile 152 and at least one review-page 154. At least one review-page 154 may correspond to one of at least one pilot avatar 110, whereby the user may write and display to other users a review of that corresponding pilot. Each of the at least one review-page 154 may further include a questionnaire having prompts querying specific aspects of a flying experience of the user. Prompts of the questionnaire may include such examples as, “How was your flight?”, “How was the plane condition?”, and “How was the Stewardess?” These are examples of inclusions on the questionnaire, and are not intended to be limitations of what questions may be implemented. Biographical information 114 may include any combination of the following: number of flying hours; number of airline accidents; age; height; weight; religion; and race. Credentials 116 of the pilot may include any of the following: education; flight school graduated from; certificates held; licenses held; and work history. Other biographical information, credentials, and auxiliary data may be provided in some embodiments.

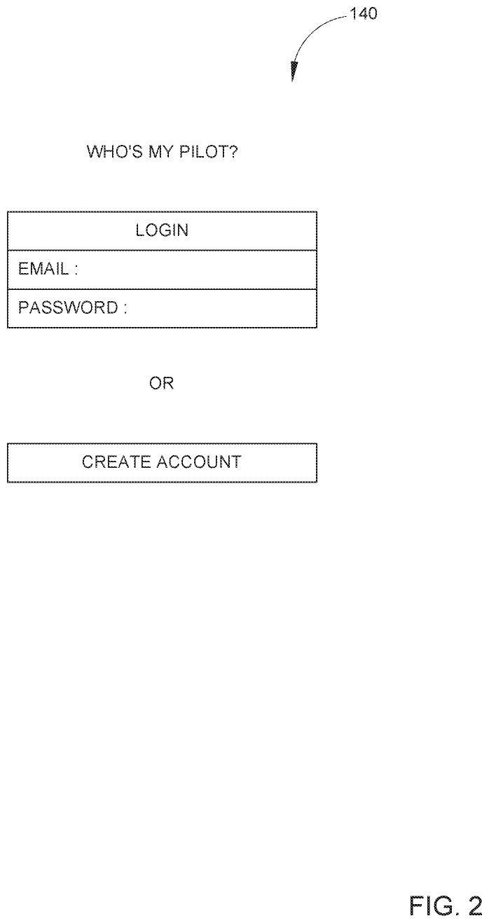

FIG. 2 shows an example graphic design of the pilot information portal of FIG. 1, according to an embodiment of the present disclosure. Illustrated is an example login page of the user-interface 140. As shown, the login page may allow a user to access a user-account by providing an email and/or username along with a password associated with the user-account. The user may use this user-account to obtain information relating to that user and post information (i.e. pilot reviews) under that user's name associated with the user-account. If no account for that user exists, the user may create an account. In some embodiments, categories may be provided on the login page (or on another page of the interface) enabling users to choose different portals for different transportation methods (i.e. airlines, subways, buses, etc.).

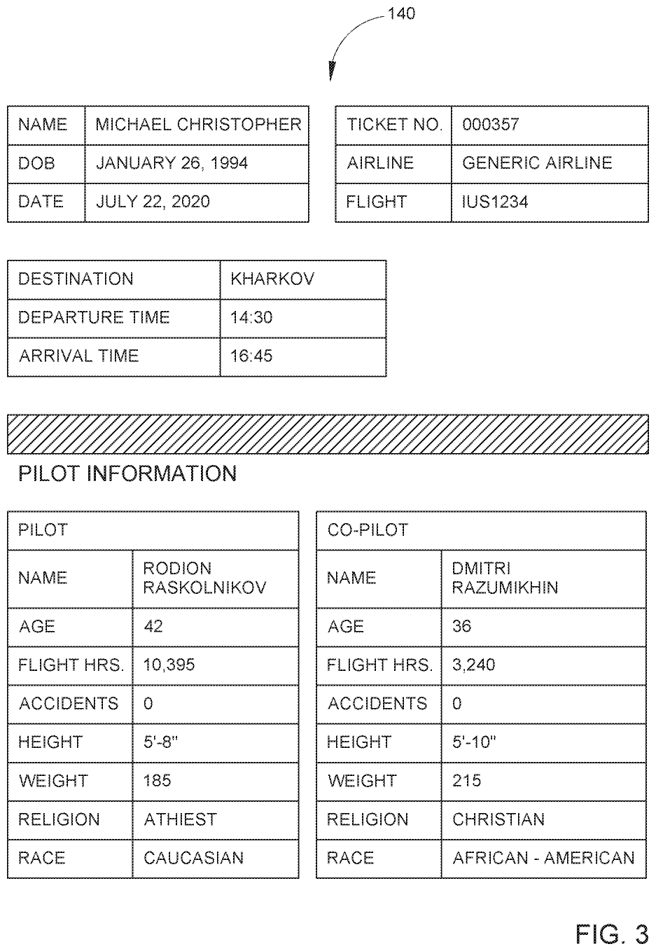

FIG. 3 is an example graphic design view of the pilot information portal of FIG. 1, according to an embodiment of the present disclosure. Illustrated is an example ticket information and pilot information page of the user-interface 140. Ticket information, user information, pilot information, co-pilot information, and other data may be displayed, as illustrated.

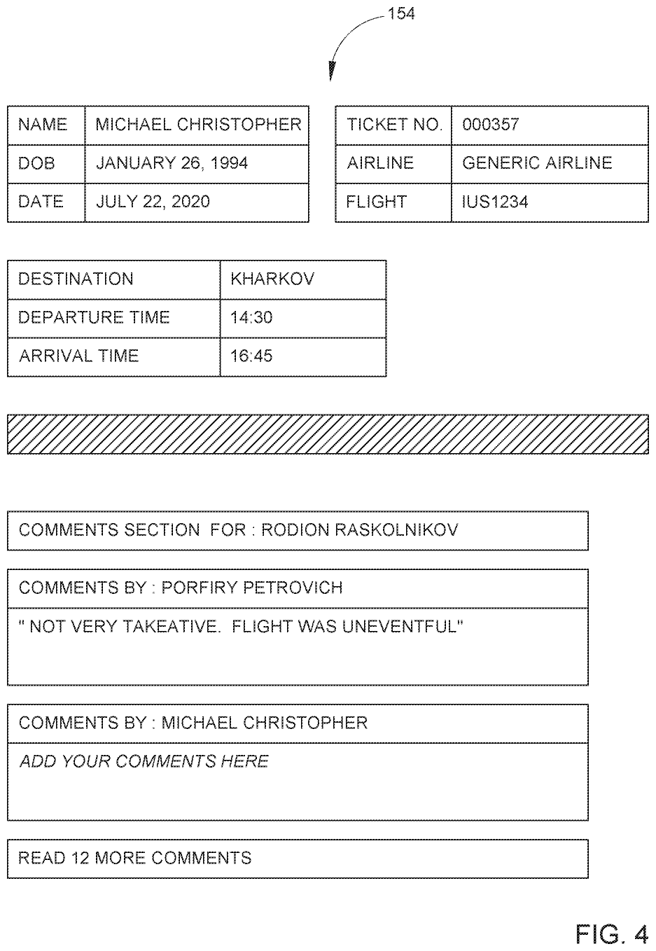

FIG. 4 is an example graphic design of the pilot information portal of FIG. 1, according to an embodiment of the present disclosure. Illustrated is an example of the graphic design of at least one review-page 154. In some embodiments, the review page may include a questionnaire having such questions as, “How was your flight?” “How was the plane condition?” “How was the Stewardess?” and others. At least one review-page 154 may be embedded within user-interface 140 (FIG. 3). As before, relevant data of user-interface 140 may be displayed on at least one review-page 154. However, various displays, portals, and user navigation means for reading and writing comments about a pilot may be provided. Furthermore, at least one review-page 154 may include provisions for uploading and displaying pictures.

It should be understood that the illustrations of client-side display interface 130 and user-interface 140 are examples of the graphics designs which may be implemented. The graphic designs and the order and orientations of the components of these interfaces are not necessarily intended to be limitations on the way that these interfaces may be designed graphically.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pilot information portal comprising:
at least one pilot avatar corresponding to a pilot including
at least one image depicting a face of the pilot,
biographical information of the pilot,
credentials of the pilot;
a server containing digital information, the digital information comprising the at least one pilot avatar;
at least one client-side display interface in communication with the server, the at least one client-side display interface able to display the at least one pilot avatar;
a user-interface enabling a user to browse the at least one pilot avatar; and
a social-network accessible via the user-interface including
at least one user-profile,
at least one review-page, each of the at least one review-page corresponding to one of the at least one pilot avatars, whereby the user may write and display to other users a review of the pilot.

2. The pilot information portal of claim 1, wherein the biographical information comprises:
number of flying hours;
number of airline accidents;
age;
height;
weight;
religion; and
race.

3. The pilot information portal of claim 1, wherein the credentials of the pilot comprise:
education;
flight school graduated from;
certificates held;
licenses held; and
work history.

4. The pilot information portal of claim 1, wherein each of the at least one review-page further includes
a questionnaire having prompts querying specific aspects of a flying experience of the user.

5. The pilot information portal of claim 4, wherein the prompts of the questionnaire comprise
“How was your flight?”;
“How was the plane condition?”; and
“How was the Stewardess?”.

6. The pilot information portal of claim 1, wherein the user-interface displays ticket information.

7. A pilot information portal comprising:
at least one pilot avatar corresponding to a pilot including
at least one image depicting a face of the pilot,
biographical information of the pilot,
credentials of the pilot;
a server containing digital information, the digital information comprising the at least one pilot avatar;
at least one client-side display interface in communication with the server, the at least one client-side display interface able to display the at least one pilot avatar;
a user-interface enabling a user to browse the at least one pilot avatar; and
a social-network accessible via the user-interface including
at least one user-profile,
at least one review-page, each of the at least one review-page corresponding to one of the at least one pilot avatars, whereby the user may write and display to other users a review of the pilot;
wherein each of the at least one review-page further includes a questionnaire having prompts querying specific aspects of a flying experience of the user;
wherein the biographical information comprises:
number of flying hours,
number of airline accidents,
age,
height,
weight,
religion, and
race; and
wherein the credentials of the pilot comprise:
education,
flight school graduated from,
certificates held,
licenses held, and
work history.
